(19) United States
(12) Patent Application Publication
(10) Pub. No.: US 2010/0007864 A1
(43) Pub. Date: Jan. 14, 2010

(54) SCANNING EXPOSURE APPARATUS AND METHOD OF MANUFACTURING DEVICE

(75) Inventor: Go Tsuchiya, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/498,108

(22) Filed: Jul. 6, 2009

(30) Foreign Application Priority Data
Jul. 8, 2008 (JP) 2008-178371

(51) Int. Cl. G03B 27/42

(52) U.S. Cl. 355/53

(57) ABSTRACT

A scanning exposure apparatus which transfers, onto a substrate, a pattern on a reticle illuminated with pulse light whose light intensity distribution has an isosceles trapezoidal shape along a scanning direction of the substrate comprises a controller configured to obtain a relationship between a number of pulses received by the substrate while the substrate moves by a unit amount in the scanning direction and unevenness of exposure on the substrate which changes in accordance with the number of pulses received and the shape of the light intensity distribution.

### BACKGROUND OF THE INVENTION

1. Field of the Invention

The present invention relates to a scanning exposure apparatus and a method of manufacturing a device.

2. Description of the Related Art

As a method of forming a predetermined circuit pattern on a semiconductor, a process method using lithography is known well. The lithography is a process method of exposing a semiconductor substrate (wafer) coated with a photosensitive organic film (photoresist) to a predetermined pattern by irradiating a reticle on which a circuit pattern is formed with light.

Recently, with an increase in the integration of LSIs (Large Scale Integrated circuits), further miniaturization of circuit patterns has been used. To improve the process accuracy in the above process method using lithography, the resolution of an exposure apparatus which performs exposure is also improved.

As indicated by the following equation, it is known that the resolution of an exposure apparatus is proportional to a wavelength λ of a light source and is inversely proportional to the NA (Numeric Aperture) of a projection lens. Note that k1 represents a proportional constant.

Resolution=k1×(λ/NA)

Therefore, to improve the resolution of the exposure apparatus, it suffices to shorten the wavelength of a light source or increase the NA of the projection lens.

In order to shorten the wavelength of a light source, an excimer laser is used as a light source. When scanning exposure is to be performed by using an exposure apparatus using an excimer laser of a pulse oscillation system as a light source, to set an exposure light quantity as a target value, the scanning speed of a reticle and wafer, the oscillation frequency of the laser, and an irradiation energy per pulse are determined. The target value of this exposure light quantity will be referred to as a “target integrated exposure light quantity” hereinafter.

Assume that exposure is performed by using pulse light having a rectangular intensity distribution in the scanning direction. In this case, when a reticle (or a wafer) is to be exposed to an integral number of pulses of pulse light, since all the exposure areas are irradiated with the same number of pulses of pulse light, no unevenness of exposure occurs.

If there is unevenness of illuminance in a non-scanning direction of an irradiation area, the width of an illumination area in the scanning direction is changed at each position in the non-scanning direction to equalize integrated exposure light quantities at any positions in the non-scanning direction. In such a case, however, the boundaries of pulses of pulse light overlap to cause unevenness of exposure in a light quantity corresponding to one pulse. This unevenness of exposure corresponding to one pulse is not a concern when the number of pulses used for exposure is large (e.g., several hundred pulses or more). However, as the number of pulses used for exposure is decreased to improve the throughput, unevenness of exposure corresponding to one pulse greatly affects a target integrated exposure light quantity.

Japanese Patent Laid-Open No. 08-236438 discloses a technique of reducing unevenness of exposure corresponding to one pulse. Japanese Patent Laid-Open No. 08-236438 also proposes a technique of performing illumination with a symmetrical trapezoidal intensity distribution obtained by gradually changing an intensity distribution in a boundary area in the scanning direction. Japanese Patent Laid-Open No. 08-236438 also proposes a technique of performing illumination with a trapezoid-like shape obtained by nonlinearly changing an intensity distribution at least from one end portion to a point corresponding to the maximum light intensity.

Even with an intensity distribution having a trapezoidal shape or trapezoid-like shape along the scanning direction, unevenness of exposure may occur depending on the relationship between the scanning speed and the intensity distribution of pulse light in the scanning direction. There is also proposed an exposure light quantity control technique of obtaining the relationship between the number of pulses received on a wafer and unevenness of exposure in advance and controlling the number of pulses received so as to reduce unevenness of exposure with respect to a target integrated exposure light quantity (see Japanese Patent Laid-Open No. 08-179514).

Using the technique described in Japanese Patent Laid-Open No. 08-179514 can obtain the number of pulses received which minimizes unevenness of exposure. However, as also described in Japanese Patent Laid-Open No. 08-236438, in some cases, illumination areas at the respective positions in the non-scanning direction have different widths (slit widths) in the scanning direction. For this reason, even if the number of pulses received which reduces unevenness of exposure is determined based on the light intensity distribution in the scanning direction at a given position in the non-scanning direction, there is a possibility that unevenness of exposure will increase depending on a position in the non-scanning direction.

### SUMMARY OF THE INVENTION

The present invention provides a scanning exposure apparatus which has small unevenness of exposure even with a scanning speed offset and an offset of the light intensity distribution of pulse light.

According to one aspect of the present invention, there is provided a scanning exposure apparatus which transfers, onto a substrate, a pattern on a reticle illuminated with pulse light whose light intensity distribution has an isosceles trapezoidal shape along a scanning direction of the substrate comprises a controller configured to obtain a relationship between a number of pulses received by the substrate while the substrate moves by a unit amount in the scanning direction and unevenness of exposure on the substrate which changes in accordance with the number of pulses received and the shape of the light intensity distribution.

According to another aspect of the invention, there is provided a scanning exposure apparatus which transfers, onto a substrate, a pattern on a reticle illuminated with pulse light whose light intensity distribution has an isosceles trapezoidal shape along a scanning direction of the substrate comprises a controller configured to obtain a relationship between a number of pulses received by the substrate while the substrate moves by a unit amount in the scanning direction and unevenness of exposure on the substrate which changes in accordance with the number of pulses received and the shape of the light intensity distribution and to control the number of pulses received such that an amount of the unevenness of exposure in the obtained relationship and a change amount of the unevenness of exposure which corresponds to a change in the number of pulses received becomes not more than a threshold.

The present invention can provide a scanning exposure apparatus which has small unevenness of exposure even with a scanning speed offset and an offset of the light intensity distribution of pulse light.

Further features of the present invention will become apparent from the following description of exemplary embodiments with reference to the attached drawings.

### BRIEF DESCRIPTION OF THE DRAWINGS

FIG. 1 is a schematic view of the arrangement of a scanning exposure apparatus;

FIG. 2 is a view showing an illumination area of pulse light on a substrate;

FIG. 3 is a graph showing the shape of the light intensity distribution of pulse light;

FIG. 4 is a graph showing an integrated exposure light quantity corresponding to an interval ΔX;

FIG. 5 is a graph showing the shape of the light intensity distribution of pulse light;

FIG. 6 is a graph showing the relationship between the numbers of pulses received and unevenness of exposure;

FIG. 7 is a graph showing the relationship between offsets of the numbers of pulses received and unevenness of exposure;

FIG. 8 is a graph showing the relationship between slit width offsets and unevenness of exposure;

FIG. 9 is a graph showing the relationship between the numbers of pulses received and unevenness of exposure; and

FIG. 10 is a graph showing the relationship between the numbers of pulses received and unevenness of exposure.

### DESCRIPTION OF THE EMBODIMENTS

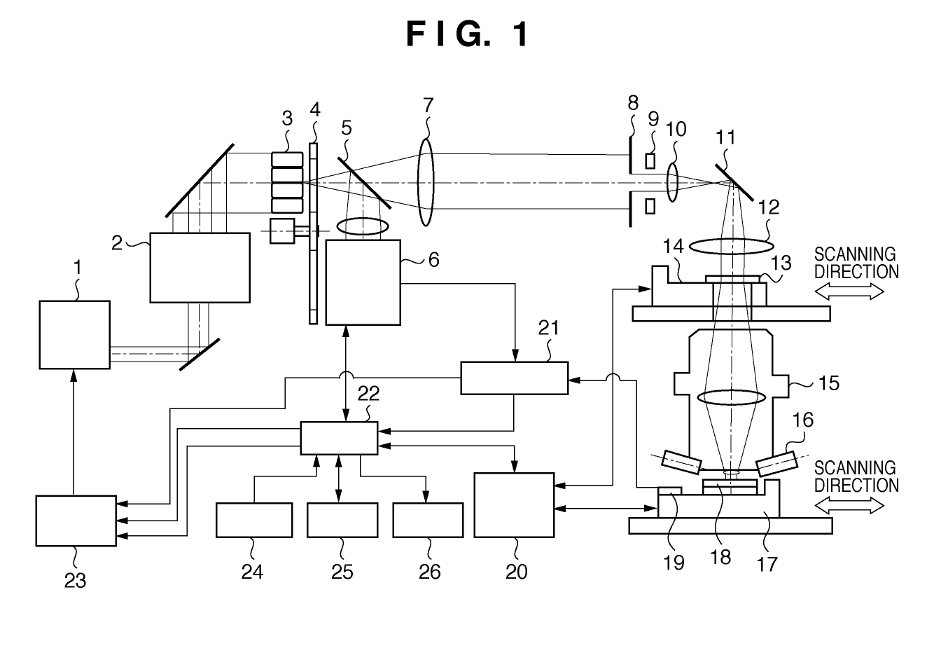

FIG. 1 is a schematic view of an example of the arrangement of a scanning exposure apparatus according to the present invention which transfers a pattern on a reticle illuminated with pulse light onto a substrate while scanning the reticle and the substrate. A light beam emitted from a light source (laser) 1 passes through a beam shaping optical system 2 to be shaped into a predetermined shape. This light beam is then incident on the light incident surface of an optical integrator 3. The optical integrator 3 includes a plurality of microlenses. Many secondary light sources are formed near the light exit surface of the optical integrator 3.

A stop turret 4 limits the size of the surface of a secondary light source by a predetermined stop. The stop turret 4 is embedded with a plurality of stops attached with numbers (illumination mode numbers) including, for example, aperture stops having different circular aperture areas for setting different coherence factor α values, a ring-shaped stop for annular illumination, and a stop for quadrupole illumination. A stop for changing the shape of an incident light source for illumination light is selected and inserted in an optical path. A photoelectric conversion device 6 detects part of pulse light reflected by a half mirror 5 as a light quantity per pulse, and outputs a corresponding analog signal to an exposure light quantity calculator 21.

A condenser lens 7 Koehler-illuminates a blind 8 with a light beam from a secondary light source near the exit surface of the optical integrator 3. A slit 9 is provided near the blind 8 to form the profile of light illuminating the blind 8 into a rectangular or arcuated shape. The slit light passing through the blind 8 and the slit 9 is formed into an image, with the illuminance and incident angle being made uniform, on a reticle 13 on which an element pattern is formed and which is conjugate to the blind 8 via a condenser lens 10, a mirror 11 and a lens 12. The aperture range of the blind 8 has a shape similar to that of a pattern exposure area of the reticle 13 at an optical magnification ratio. At the time of exposure, the blind 8 synchronously scans a reticle stage 14 and the reticle 13 at the optical magnification ratio while shielding a portion other than the exposure area of the reticle 13.

The reticle stage 14 holds the reticle 13. The slit light passing through the reticle 13 passes through a projection optical system 15 and is formed into an image again as slit light in the exposure-angle-of-view area of a plane optically conjugate to the pattern surface of the reticle 13. A focus detection system 16 detects the height and inclination of the exposed surface on a substrate (wafer) 18 held on a substrate stage (wafer stage) 17. In scanning exposure, the reticle stage 14 and wafer stage 17 travel in synchronism with each other while the wafer stage 17 is controlled based on the information obtained by the focus detection system 16 to make the exposed surface of the wafer 18 coincide with an exposure field surface. At the same time, the wafer 18 is exposed to slit light to transfer a pattern onto the photoresist layer on the wafer 18. A photoelectric conversion device 19 is mounted on the wafer stage 17 to measure the pulse light quantity of slit light on the exposure angle of view.

The arrangement of a control system according to this embodiment will be described next. A stage driving controller 20 controls the synchronous travel of the reticle stage 14 and the wafer stage 17 at the time of scanning exposure, which includes control on an exposed surface position. The exposure light quantity calculator 21 converts the electrical signal photoelectrically converted by the photoelectric conversion device 6 and the photoelectric conversion device 19 into a logical value, and outputs it to a main controller 22. Note that the photoelectric conversion device 6 is configured to be able to perform measurement even during exposure. The photoelectric conversion device 19 detects the light quantity of slit light to irradiate the wafer 18 before an exposure step, and simultaneously obtains a correlation with the light quantity detected by the photoelectric conversion device 6. Using this correlation, the photoelectric conversion device 6 converts the output value into a light quantity on the wafer 18, and uses it as a monitor light quantity for exposure light quantity control. This monitor light quantity is described as being identical to a pulse light quantity on a wafer, and a logical value (unit: bit) obtained when the exposure light quantity calculator 21 converts outputs from the photoelectric conversion device 6 and the photoelectric conversion device 19 represents a pulse light quantity itself.

A laser controller (a unit to determine a laser power and an oscillation frequency) 23 controls the oscillation frequency and output energy of a laser 1 by outputting a trigger signal and an applied voltage signal in accordance with a pulse light quantity. When generating a trigger signal and an applied voltage signal, the laser controller 23 uses a pulse light quantity signal from the exposure light quantity calculator 21 and exposure parameters from the main controller 22.

An input device 24 as a man-machine interface or a media interface inputs exposure parameters (specifically, a target integrated exposure light quantity and an integrated exposure light quantity accuracy or a stop shape) to the main controller 22. A storage unit 25 stores them. A display unit 26 displays the respective results obtained from the photoelectric conversion device 6 and the photoelectric conversion device 19, the correlation between the results obtained by the detectors, and the like.

The main controller 22 calculates/obtains a parameter group for exposure from data from the input device 24, parameters unique to the exposure apparatus, and data measured by the photoelectric conversion devices 6 and 19, and transfers the parameter group to the laser controller 23 and the stage driving controller 20. In this case, the number of pulses received indicates the number of pulses which the wafer 18 receives while moving by a unit amount in the scanning direction, and is the reciprocal of a relative displacement amount ΔX of pulse light per pulse on the wafer 18.

A method of calculating the relationship between the numbers of pulses received and unevenness of exposure in advance will be described next. The photoelectric conversion device 19 placed on the wafer stage 17 measures the light intensity distribution per pulse in an exposure area on the wafer 18. The photoelectric conversion device 19 includes line sensors arranged along the scanning direction of the wafer 18 or a photosensor which can be scanned in the scanning direction of the wafer 18, and is placed such that its light-receiving surface almost coincides with an image plane of the projection optical system 15. The main controller 22 obtains a light intensity distribution per pulse in an exposure area from a measurement result from the photoelectric conversion device 19, and calculates/obtains the relationship between the numbers of pulses received and unevenness of exposure from the light intensity distribution. The main controller 22 also sets conditions including a stage scanning speed, the light quantity of pulse light, and the oscillation frequency of the laser and performs control for the stage driving controller 20 and the laser controller 23 to obtain a target exposure light quantity. The main controller 22 forms a controller to calculate/obtain the relationship between unevenness of exposure and the numbers of pulses received and control the number of pulses received.

As a light intensity distribution in an exposure area, a value in design (design value) may be used. In this case, a light intensity distribution is manually input to the main controller 22 by using the input device 24 and stored in the storage unit 25.

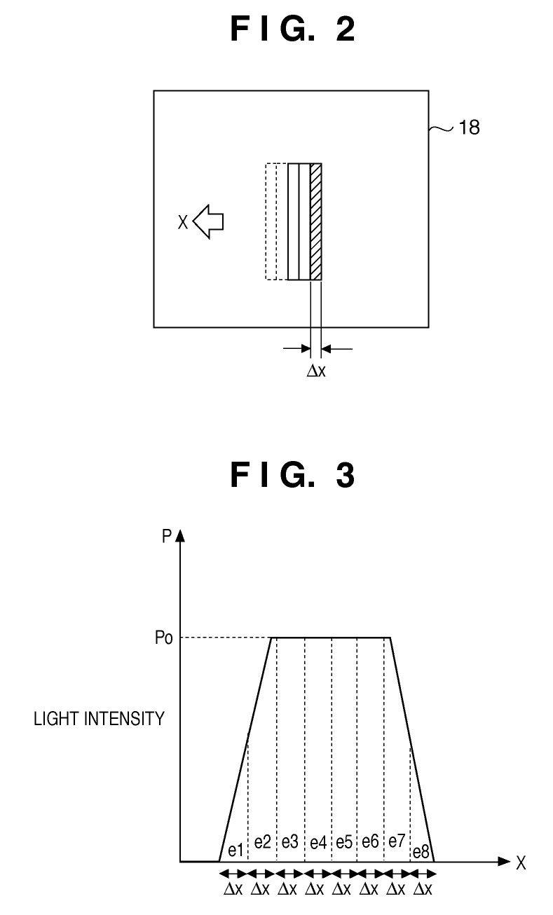

When the wafer 18 is intermittently irradiated with pulse light while the wafer 18 is continuously moving in the X direction, an exposure area is displaced by the displacement amount ΔX per pulse, and exposure is integrated, as shown in FIG. 2. Letting f be the oscillation frequency of the laser, and v be the moving speed of the wafer 18, the displacement amount ΔX is represented by

ΔX=v/f (1)

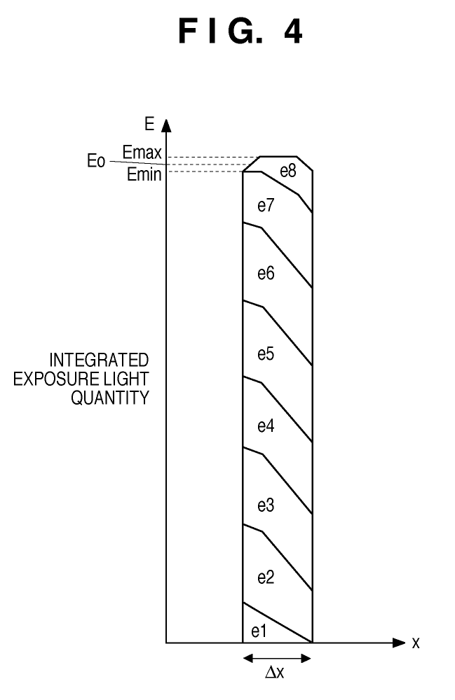

FIG. 3 is a graph showing the relationship between the light intensity distributions of pulse light in the scanning direction and the displacement amount ΔX. Referring to FIG. 3, the abscissa represents the X-coordinates of the wafer 18; and the ordinate, the light intensity. A symbol P₀ represents the maximum light intensity. On the wafer 18, exposure light quantities e1 to e8 are integrated per pulse in an interval ΔX. FIG. 4 shows an integrated exposure light quantity in the interval ΔX. Referring to FIG. 4, the abscissa represents the X-coordinates of the wafer 18; and the ordinate, the integrated exposure light quantity. According to the relationship between the light intensity distributions of pulse light and the displacement amounts shown in FIG. 3, unevenness of exposure ranging from Emax to Emin occurs in a target integrated exposure light quantity Eo in the interval ΔX.

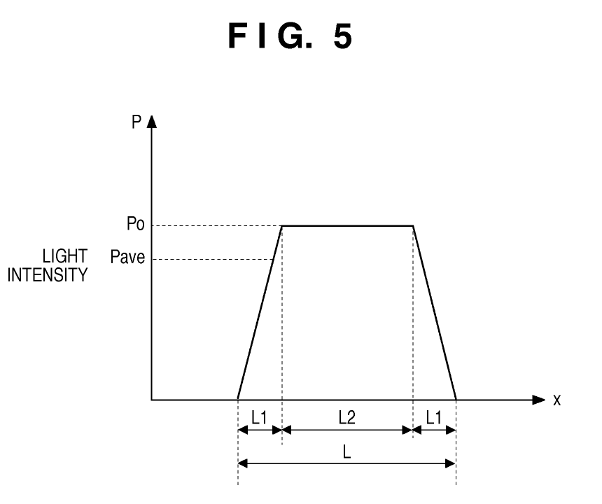

The relationship between unevenness of exposure and the numbers of pluses received of pulse light whose light intensity distribution along the scanning direction has an isosceles trapezoidal shape like that shown in FIG. 3 will be described with reference to FIG. 5. A symbol P₀ represents the maximum light intensity. A symbol Pₐᵥₑ represents the average value of the light intensity. As disclosed in Japanese Patent Laid-Open No. 08-179514, unevenness of exposure Y is obtained by using the displacement amount ΔX of the exposure area, a width L2 of a portion in which the light intensity is constant, and a width L1 of a portion in which the light intensity gradually changes as follows:

Y=smaller one of

{Y1=σ×ΔX/(2×L1×(L1+L2))

and

Y2=ε×ΔX/(2×L1×(L1+L2))} (2)

where

σ: one of remainder of L1/ΔX and (ΔX−remainder) which is smaller in absolute value (3)

ε: one of remainder of (L1+L2)/ΔX and (ΔX−remainder) which is smaller in absolute value (4)

That is, the unevenness of exposure Y on the substrate (or the wafer) changes in accordance with the number of pulses received (1/ΔX) and the shape (L1, L2) of a light intensity distribution.

Using mathematical expressions (2) to (4) given above can obtain the displacement amount ΔX of the exposure area in which unevenness of exposure Y=0 from the width L2 of the portion in which the light intensity is constant and the width L1 of the portion in which the light intensity gradually changes according to equations (5) and (6):

ΔX=(L1+L2)/N1 (5)

or

ΔX=L1/L2 (6)

where N1 and N2 are natural numbers. Obviously, in pulse light with a light intensity distribution having isosceles trapezoidal shape along the scanning direction, unevenness of exposure periodically reduces in the following cases:

when the sum of the width L1 of the portion in which the light intensity gradually changes and the width L2 of the portion in which the light intensity is constant is a natural number multiple of the displacement amount ΔX per pulse on the wafer 18, and

when the width L1 of the portion in which the light intensity gradually changes is a natural number multiple of the displacement amount ΔX per pulse on the wafer 18.

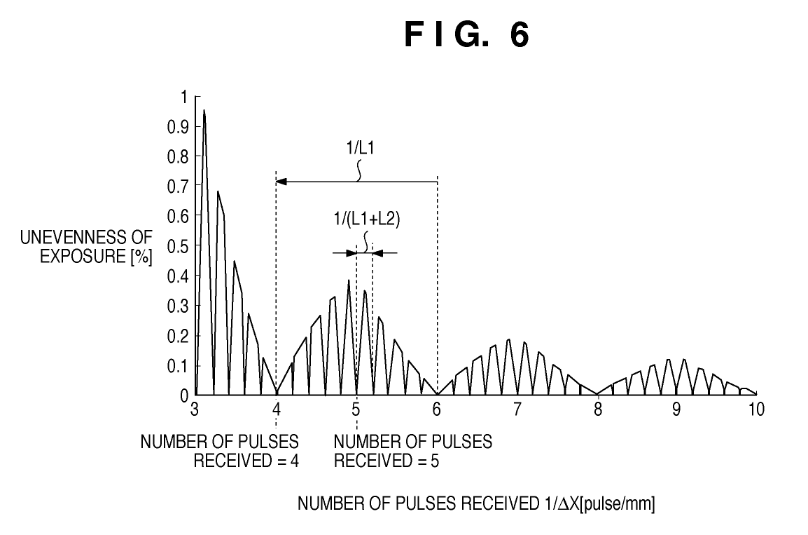

FIG. 6 shows the relationship between the numbers of pulses received and unevenness of exposure when L=5.5 mm, L1=0.5 mm, and L2=4.5 mm in FIG. 5.

Equations (5) and (6) can be modified into equations (7) and (8), respectively.

1/ΔX=N1/(L1+L2) (7)

1/ΔX=N2/L1 (8)

This indicates that the numbers of pulses received, each of which is a reciprocal 1/ΔX of the displacement amount ΔX, correspond to a portion in which unevenness of exposure reduces in a short period 1/(L1+L2) and a portion in which unevenness of exposure reduces in a long period 1/L1. FIG. 6 shows this state. As is obvious from FIG. 6, in the portion in which unevenness of exposure reduces in the short period 1/(L1+L2), even a slight offset of the number of pulses received makes unevenness of exposure steeply deteriorate because of the short period. In contrast to this, in the portion in which unevenness of exposure reduces in the long period 1/L1, even with a slight offset of the number of pulses received, unevenness of exposure is small because of the long period.

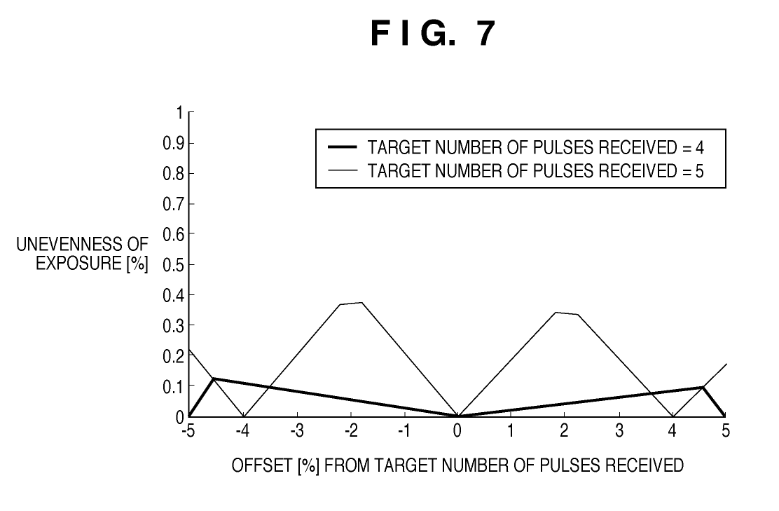

Consider a case in which number of pulses received=4 is a target number, which is an example in which unevenness of exposure reduces in the long period 1/L1, and a case in which number of pulses received=5 is a target number, which is an example in which unevenness of exposure reduces in the short period 1/(L1+L2). FIG. 7 shows the relationship between the target numbers of pulses received and unevenness of exposure in such cases. The abscissa of FIG. 7 represents offsets (%) from the target numbers of pulses received. Obviously, at a position corresponding to 5%, when target number of pulses received=4, the number of pulses received at the time of exposure becomes 4.2 which is larger than the target number of pulses received by 5%. The ordinate represents the amount of unevenness of exposure displayed in %. In addition, the thick line indicates the relationship between unevenness of exposure and offsets from the target number of pulses received which is target number of pulses received=4. The thin line indicates the relationship between unevenness of exposure and offsets from the target number of pulses received which is target number of pulses received=5.

In this case, according to equation (1), a number 1/A of pulses received is represented by

1/ΔX=f/v (9)

That the number 1/ΔX of pulses received is offset from the target number of pulses received means that the oscillation frequency f of the laser or the stage speed v has been offset from the target value for some reason.

As shown in FIG. 7, using target number of pulses received=4 at which unevenness of exposure reduces in the long period 1/L1 can make deterioration in unevenness of exposure insensitive and sufficiently reduce it even at the occurrence of an offset from the target number of pulses received as compared with the case of target number of pulses received=5. In contrast, when target number of pulses received=5 at which unevenness of exposure reduces in the short period 1/(L1+L2), deterioration in unevenness of exposure is sensitive to an offset from the target number of pulses received.

Assume a case in which the slit width of an illumination area which is the width in the scanning direction varies depending on the position in a non-scanning direction. The non-scanning direction is a direction perpendicular to the scanning direction on a wafer. Assume that the width L1 of the portion in which the light intensity gradually changes even with changes in slit width hardly changes.

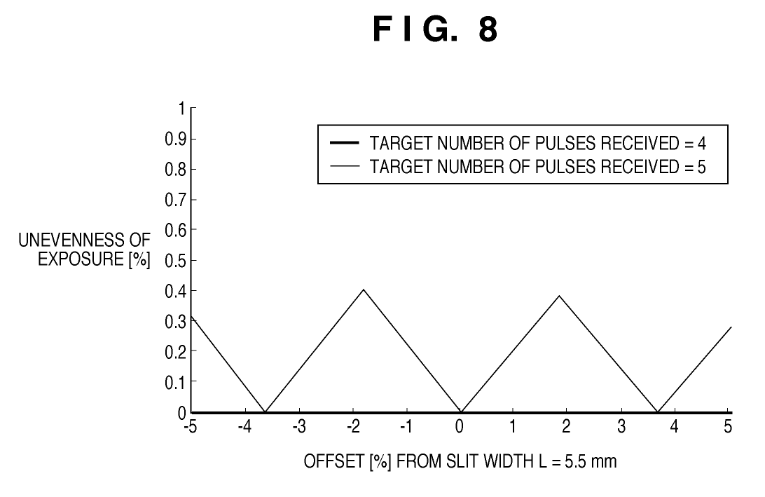

As described above, consider a case in which number of pulses received=4 is a target number at which unevenness of exposure reduces in the long period 1/L1 and a case in which number of pulses received=5 is a target number at which unevenness of exposure reduces in the short period 1/(L1+L2). FIG. 8 shows the relationship between slit width offsets and unevenness of exposure. The abscissa in FIG. 8 represents offsets relative to slit width L=5.5 mm. 0% on the abscissa indicates slit width L=5.5 mm (L1=0.5 mm, L2=4.5 mm). In addition, 5% on the abscissa indicates L=5.775 mm (L1=0.5 mm, L2=4.775 mm) which is larger than slit width L=5.5 mm by 5%. The ordinate represents the amount of unevenness of exposure in %. The thick line indicates the results obtained when target number of pulses received=4 at which unevenness of exposure reduces in the long period 1/L1. The thin line indicates the results obtained when target number of pulses received=5 at which unevenness of exposure reduces in the short period 1/(L1+L2).

As shown in FIG. 8, using target number of pulses received=5 at which unevenness of exposure reduces in the short period 1/(L1+L2) will degrade unevenness of exposure even with a slight change in slit width.

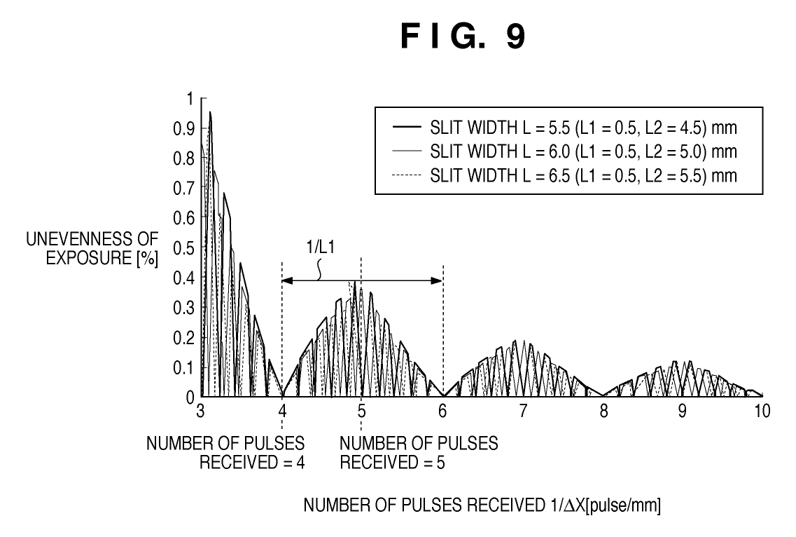

FIG. 9 shows the relationship between the numbers of pulses received and the amounts of unevenness of exposure based on slit width offsets. FIG. 9 shows results obtained with the following three slit widths:

slit width L=5.5 mm (L1=0.5 mm, L2=4.5 mm)

slit width L=6.0 mm (L1=0.5 mm, L2=5.0 mm)

slit width L=6.5 mm (L1=0.5 mm, L2=5.5 mm)

FIG. 9 shows that at target number of pulses received=5 at which unevenness of exposure reduces in the short period 1/(L1+L2), the unevenness of exposure deteriorates due to a slit width offset.

That is, according to the results shown in FIGS. 7, 8, and 9, setting the number of pulses received to an integer multiple of the long period 1/L1 can reduce the possibility that unevenness of exposure will deteriorate even when an offset of the number of pulses received occurs or the slit width changes. Assume that the available range of the numbers of pulses received is the range in which the short period 1/(L1+L2) in which unevenness of exposure reduces continues for one period or more when a threshold for the amount of unevenness of exposure is set to 0.1%, and the amount of unevenness of exposure can be made equal to or less than the threshold. The purpose of this setting is not to select the number of pulses received which is an integer multiple of the short period 1/(L1+L2).

When L=5.5 mm, L1=0.5 mm, and L2=4.5 mm, 1/(L1+L2)=1/(0.5+4.5)=0.2 (10)

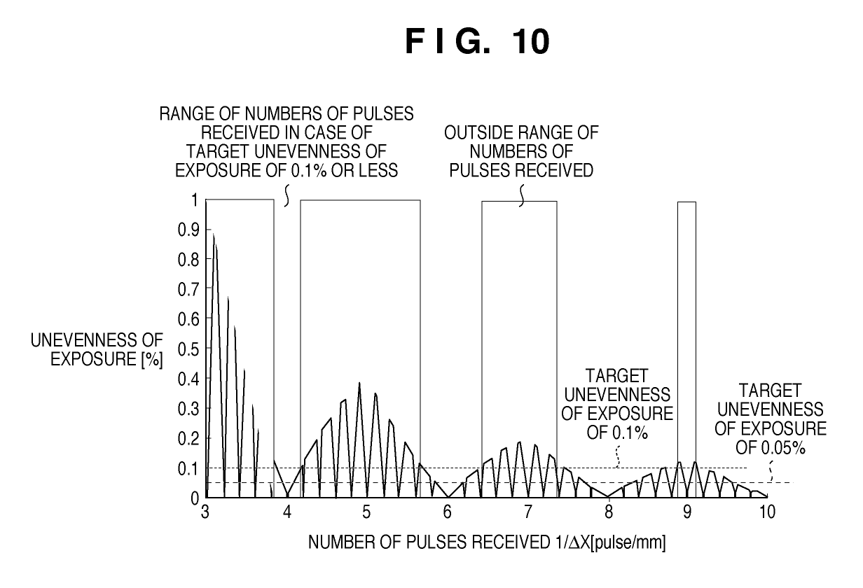

FIG. 10 shows the result obtained by applying the above range of the numbers of pulses received to the relationship shown in FIG. 6. As shown in FIG. 10, it can be confirmed that the range of the numbers of pulses received in which unevenness of exposure reduces which occurs in the short period 1/(L1+L2), is excluded to some extent.

Consider, for example, a case in which a target unevenness of exposure as a threshold for the amount of unevenness of exposure is set to a small value, i.e., approximately 0.05% or less. Referring to FIG. 10, when the target unevenness of exposure is approximately 0.05% or less, a portion near number of pulses received=4 also belongs to the range of the numbers of pulses received. If, however, the target unevenness of exposure is set to a small value of approximately 0.05% or less, the unevenness of exposure exceeds 0.05% which is the threshold for the amount of unevenness of exposure even with a slight change in the number of pulses received near number of pulses received=4. This is because, since the threshold for the amount of unevenness of exposure is extremely small, the amount of unevenness of exposure is too sensitive to an offset of the number of pulses received even in a portion in which the amount of unevenness of exposure is supposed to reduce in the long period 1/L1.

In order to minimize the occurrence of unevenness of exposure, the number of pulses received which makes the change amount of unevenness of exposure in the relationship between the numbers of pulses received and the amounts of unevenness of exposure as shown in FIG. 10, e.g., the gradient of the unevenness of exposure, become equal to or less than a threshold, is selected. In the case shown in FIG. 10, for example, a number near number of pulses received=6 or number of pulses received=8, at which the gradient of unevenness of exposure relative to the number of pulses received is small, is selected.

When the shape of the light intensity distribution of pulse light changes in accordance with the position on a wafer in a non-scanning direction, unevenness of exposure changes in accordance with a change in the shape of the light intensity distribution. In such a case, the shape of the light intensity distribution to be used to find the range of the numbers of pulses received can be formed into the shape of a light intensity distribution at a position at which the width (slit width) of pulse light in the scanning direction is minimum. According to mathematical expressions (2), (3), and (4), maximum unevenness of exposure occurs in accordance with the shape of a light intensity distribution at the position corresponding to the minimum slit width. Therefore, selecting the shape of a light intensity distribution at the position corresponding to the minimum slit width will increase the possibility that unevenness of exposure will become equal to or less than the target value in the entire range in the non-scanning direction.

In addition, as a slit width, the width set by adjusting the slit width at each position in the non-scanning direction so as to reduce unevenness of illuminance in the non-scanning direction or an adjustment target width is used. This is because actual exposure is likely to be performed with the width obtained by adjusting the slit width or the adjustment target width.

When calculating the width L1 of the portion in which the light intensity gradually changes and the width L2 of the portion in which the light intensity is constant, it can be assumed that L1 will hardly change. In this case, it is possible to extract only a portion L1 in which the light intensity gradually changes from the intensity distribution design value or measured value of pulse light in the non-scanning direction. It suffices to calculate the width L2 of the portion in which the light intensity is constant from the slit width L after adjustment or the adjustment target width L, with L1=constant value, according to the following equation:

L2=L−2×L1 (11)

Performing the above procedure can find the range of the numbers of pulses received which makes unevenness of exposure become almost equal to or less than the target value. Using the number of pulses received within the range of the numbers of pulses received can implement exposure light quantity control that can satisfy the requirement for a target integrated exposure light quantity while reducing unevenness of exposure, even if the slit width varies depending on each position in the non-scanning direction.

Every time the shape of the light intensity distribution of pulse light is changed by changing illumination conditions, the control system calculates/obtains the relationship between unevenness of exposure and the numbers of pulses received again and selects the number of pulses received which reduces unevenness of exposure.

A method of manufacturing a device such as a semiconductor integrated circuit device and liquid crystal display device using the above scanning exposure apparatus will be exemplified next.

Devices are manufactured by an exposing step of transferring by exposure a pattern onto a substrate using the above scanning exposure apparatus, a developing step of developing the substrate exposed in the exposing step, and other known steps (e.g., etching, resist removal, dicing, bonding, and packaging steps) of processing the substrate developed in the developing step.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-178371, filed Jul. 8, 2008, which is hereby incorporated by reference herein in its entirety.

What is claimed is:

1. A scanning exposure apparatus which transfers, onto a substrate, a pattern on a reticle illuminated with pulse light whose light intensity distribution has an isosceles trapezoidal shape along a scanning direction of the substrate, the apparatus comprising
a controller configured to obtain a relationship between a number of pulses received by the substrate while the substrate moves by a unit amount in the scanning direction and unevenness of exposure on the substrate which changes in accordance with the number of pulses received and the shape of the light intensity distribution and to control the number of pulses received such that an amount of the unevenness of exposure in the obtained relationship and a change amount of the unevenness of exposure which corresponds to a change in the number of pulses received becomes not more than a threshold.

2. The apparatus according to claim 1, wherein when the shape of the light intensity distribution changes in accordance with a position on the substrate in a non-scanning direction perpendicular to the scanning direction and the unevenness of exposure changes in accordance with a change in the shape of the light intensity distribution, the controller obtains a relationship between the number of pulses received and unevenness of exposure at a position in the non-scanning direction at which maximum unevenness of exposure occurs.

3. The apparatus according to claim 1, wherein when the shape of the light intensity distribution changes in accordance with a position on the substrate in a non-scanning direction perpendicular to the scanning direction and the unevenness of exposure changes in accordance with a change in the shape of the light intensity distribution, the controller obtains a relationship between the number of pulses received and unevenness of exposure which corresponds to the shape of the light intensity distribution at a position at which a width of the pulse light in the scanning direction is minimum.

4. The apparatus according to claim 1, wherein the controller controls the number of pulses received so as to make the unevenness of exposure become not more than 0.05%.

5. The apparatus according to claim 1, wherein when the shape of the light intensity distribution is changed, the controller obtains a relationship between the unevenness of exposure and the number of pulses received again, and controls the number of pulses received based on an amount of the unevenness of exposure in the obtained relationship and a change amount of the unevenness of exposure which corresponds to a change in the number of pulses received.

6. A method of manufacturing a device, the method comprising:
scanning-exposing a substrate by using a scanning exposure apparatus configured to transfer, onto the substrate, a pattern on a reticle illuminated with pulse light whose light intensity distribution has an isosceles trapezoidal shape along a scanning direction of the substrate;
developing the scanning-exposed substrate; and
processing the developed substrate to manufacture the device,
wherein the scanning exposure apparatus includes a controller configured to obtain a relationship between a number of pulses received by the substrate while the substrate moves by a unit amount in the scanning direction and unevenness of exposure on the substrate which changes in accordance with the number of pulses received and the shape of the light intensity distribution and to control the number of pulses received such that an amount of the unevenness of exposure in the obtained relationship and a change amount of the unevenness of exposure which corresponds to a change in the number of pulses received becomes not more than a threshold.

7. A scanning exposure apparatus which transfers, onto a substrate, a pattern on a reticle illuminated with pulse light whose light intensity distribution has an isosceles trapezoidal shape along a scanning direction of the substrate, the apparatus comprising
a controller configured to obtain a relationship between a number of pulses received by the substrate while the substrate moves by a unit amount in the scanning direction and unevenness of exposure on the substrate which changes in accordance with the number of pulses received and the shape of the light intensity distribution.

8. The apparatus according to claim 7, wherein the controller is configured to control the number of pulses received such that an amount of the unevenness of exposure and a change amount of the unevenness of exposure become not more than a threshold.

9. The apparatus according to claim 7, wherein the change amount of the unevenness of exposure corresponds to a change in the number of pulses received.

10. A method of manufacturing a device, the method comprising:
scanning-exposing a substrate by using a scanning exposure apparatus configured to transfer, onto the substrate, a pattern on a reticle illuminated with pulse light whose light intensity distribution has an isosceles trapezoidal shape along a scanning direction of the substrate;
developing the scanning-exposed substrate; and
processing the developed substrate to manufacture the device,
wherein the scanning exposure apparatus includes a controller configured to obtain a relationship between the number of pulses received by the substrate while the substrate moves by a unit amount in the scanning direction and unevenness of exposure on the substrate which changes in accordance with the number of pulses received and the shape of the light intensity distribution.
